(19) United States
(12) Patent Application Publication
(10) Pub. No.: US 2025/0328586 A1
(43) Pub. Date: Oct. 23, 2025

(54) External Chaincode Executor Controller, Peer Controller, and Methods for Use in the Same

(71) Applicant: Huawei Cloud Computing Technologies Co., Ltd., Guizhou (CN)

(72) Inventors: Artem Barger, Hod Hasharon (IL); Avigail Oron, Hod Hasharon (IL); Boris Goldfeld, Hod Hasharon (IL); Gregory Vortman, Hod Hasharon (IL); David Alexandrovich, Hod Hasharon (IL); Daniel Karalnik, Hod Hasharon (IL)

(73) Assignee: Huawei Cloud Computing Technologies Co., Ltd., Guizhou (CN)

(21) Appl. No.: 19/246,194

(22) Filed: Jun. 23, 2025

Related U.S. Application Data
(63) Continuation of application No. PCT/EP2022/087287, filed on Dec. 21, 2022.

(51) Int. Cl. G06F 16/903; G06F 8/71; G06F 16/901

(52) U.S. Cl. CPC G06F 16/90335; G06F 8/71; G06F 16/9024

(57) ABSTRACT

An external chaincode (CC) executor controller includes a block tracking circuit to register for events and a first data model type data access layer (DAL) to receive a data point and convert the data point to a native first data model type to be stored in a first data model type database. Furthermore, a second data model type DAL receives the data point and converts the data point to a native second data model type to be stored in a second data model type database. Moreover, a block committer circuit receives a new block notification and determines that the new block notification includes a smart contract data model, and in response thereto dispatch the smart contract to the first data model type DAL or to the second data model type DAL to support delegated execution of the smart contract data model efficiently and reliably.

### CROSS-REFERENCE TO RELATED APPLICATIONS

This is a continuation of International Patent Application No. PCT/EP2022/087287 filed on Dec. 21, 2022, which is hereby incorporated by reference in its entirety.

### TECHNICAL FIELD

The present disclosure relates generally to the field of blockchain technology and in particular, to an external chaincode (CC) executor controller and a method for use in the external CC executor controller. Furthermore, the present disclosure further relates to a peer controller and a method for use in the peer controller configured to receive the script from the external CC executor controller.

### BACKGROUND

A blockchain platform includes multiple blockchain nodes that include an append-only, a tamper-proof distributed ledger, and a chain of blocks. Each block from the chain of blocks in each blockchain node includes a batch of transactions and a reference point that points to a previous block, such as by storing a hashed value of the previous block that is generated by a cryptographic hash function. Moreover, each blockchain node in the blockchain platform maintains a current snapshot of a global state that allows data lookup, which is stored in the distributed ledger that is managed within a world-state database.

A world state database stores a key-value abstraction that is used to capture updates of the keys that are altered by the transactions. However, an addition of a new world state database(s) or a replacement of the new world state database(s) with the existing world state database is very complex in blockchain platforms as the world state database is integrated into an architecture of the blockchain platform and smart contract application programming interfaces (APIs). Therefore, it is complex to add or to replace the new world state database with a non-conventional data model in the blockchain platforms, which is not desirable. However, the blockchain platforms fail to support different database(s) with non-conventional data models, and there exists a technical problem of how to provide delegated execution of the smart contracts.

Therefore, in light of the foregoing discussion, there exists a need to overcome the aforementioned drawbacks associated with the blockchain platforms and methods associated with an integration of new data models into smart contract APIs.

### SUMMARY

The present disclosure provides an external CC executor controller and a method for use in the external CC executor controller. The present disclosure further provides a peer controller and a method for use in the peer controller configured to receive the script from the external CC executor controller. The present disclosure provides a solution to the existing problem of how to provide delegated execution of the smart contracts efficiently and reliably. An objective of the present disclosure is to provide a solution that overcomes at least partially the problems encountered in other approaches and provides an improved external executor CC controller, such as through a non-intrusive integration of new data models into smart contract APIs.

One or more objectives of the present disclosure are achieved by the solutions provided in the enclosed independent claims. Advantageous implementations of the present disclosure are further defined in the dependent claims.

In one aspect, the present disclosure provides an external CC executor controller that includes a block tracking circuit configured to register for events with one or more peer controllers, a block committer circuit, a first data model type chaincode interface, a first data model type data access layer (DAL) configured to receive a data point and convert it to a native first data model type and store it in a first data model type database. Furthermore, the external CC executor controller includes a second data model type chaincode interface and a second data model type DAL configured to receive a data point and convert it to a native second data model type and store it in a second data model type database. Moreover, the block committer circuit is configured to receive a new block notification, determine that the new block notification includes a smart contract data model, and in response thereto. Furthermore, the block committer circuit is configured to dispatch the smart contract data model to the first data model type DAL via the first data model type chaincode interface when the smart contract data model relates to the first data model type and dispatch the smart contract data model to the second data model type DAL via the second data model type chaincode interface when the smart contract data model relates to the second data model type.

The external CC executor controller is configured to support the delegated execution of the smart contract data model efficiently and reliably. Furthermore, the external CC executor controller provides an efficient processing of the time series data model type databases (i.e., Internet of things (IoT) workloads), graph data model type databases, and the like. Moreover, the external CC executor controller is configured to detect the non-key-value database that is provisioned to compute new CC versions, such as by registering new block events that are used to support different data model types in a blockchain system.

In an implementation form, the external CC executor controller is configured to receive a CC query, determine for which DAL the CC query is related to and cause the matching DAL to perform the query on the connected database.

The external CC executor controller supports new data models to operate within a smart contract without changing the existing implementation of the blockchain platform.

In a further implementation form, the first data model type DAL is configured to ingest received point elements, utilizing an ingestion method, into the first data model type database and performing queries over the first data model type database.

In such implementation form, the first data model type DAL is configured to allow efficient and effective execution of the queries by the first data model type database with reduced latency, such as by allowing efficient detection of the type of the data model.

In a further implementation form, the ingestion method causes the external CC executor controller to convert an incoming point element into a key-value pair as Key=DATAMODEL_ID_<hash of incoming point element>, and Value=serialization of the incoming point element, and call the peer controller to inject the generated key-value pair.

Advantageously, the ingestion method allows an efficient and reliable detection of the native data type, such as the first native data type and the second native data type for the generation of the unique key.

In a further implementation form, the first data model type DAL is configured to identify received key-value pairs that are encapsulating elements of the first smart contract data model type utilizing a discrimination method, wherein the discrimination method causes the external CC executor controller to accept key-value pair, determine if the key starts with “DATAMODEL_ID_” and then return TRUE and if not return FALSE.

In such implementation, the first data model type DAL is used to identify the encapsulated data types efficiently and reliably.

In a further implementation form, the block committer circuit is configured to utilize a Hyperledger Fabric block delivery book keeping to keep track of processed blocks and request only the blocks it has not fully processed yet. The Hyperledger Fabric block delivery book keeping allows a delegated execution of smart contracts that support different data model types.

In a further implementation form, the first data model type is a time series data type.

In a further implementation form, the first data model type is a graph data type.

In such implementations, the external CC executor controller allows the delegated smart contract execution that includes new database-specific plugins to provide different operations that are executed by different data model types, such as the time series data type and the graph data type.

In another aspect, the present disclosure provides a peer controller configured to receive a script from an external CC executor controller according to any preceding claim. Moreover, the peer controller is configured to provide the external CC executor with a notification of a new block upon deploying a new chaincode version on the peer.

Beneficially, the peer controller is configured to support delegated execution of the smart contracts, such as by deploying the new chaincode version on the peer controller with an improved efficiency and reduced latency.

In yet another aspect, the present disclosure provides a method for use in an external CC executor controller comprising a block tracking circuit configured to register for events with one or more peer controllers, a block committer circuit, a first data model type chaincode interface, a first data model type DAL configured to receive a data point and convert it to a native first data model type data type and store it in a first data model type database, a second data model type chaincode interface, and a second data model type DAL configured to receive a data point and convert it to a native second data model type data type and store it in second data model type database, wherein the method comprises receiving a new block notification, determining that the new block notification comprises a smart contract data model, and in response thereto. Furthermore, the method comprises dispatching the smart contract to the first data model type DAL via the first data model type chaincode interface when the smart contract data model relates to a first data model type and dispatching the smart contract to the second data model type DAL via the second data model type chaincode interface when the smart contract data model relates to a second data model type.

The method achieves all the advantages and technical effects of the external CC executor controller of the present disclosure.

In another aspect, the present disclosure provides a method for use in a peer controller configured to receive a script from an external CC executor controller. The method comprises providing the external CC executor with a notification of a new block upon deploying a new chaincode version on the peer.

The method achieves all the advantages and technical effects of the peer controller of the present disclosure.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application, as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams:

FIG. 1 is a block diagram of an external chaincode executor controller, in accordance with an embodiment of the present disclosure;

FIG. 2 is a flowchart of a method for use in an external CC executor controller, in accordance with an embodiment of the present disclosure;

FIG. 3 is a block diagram that depicts a peer controller configured to receive a script from an external CC controller, in accordance with an embodiment of the present disclosure;

FIG. 4 is a flowchart of a method for use in a peer controller configured to receive a script from an external CC executor controller, in accordance with an embodiment of the present disclosure; and

FIG. 5 is a diagram that depicts an architecture that allows a delegated execution of smart contracts, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

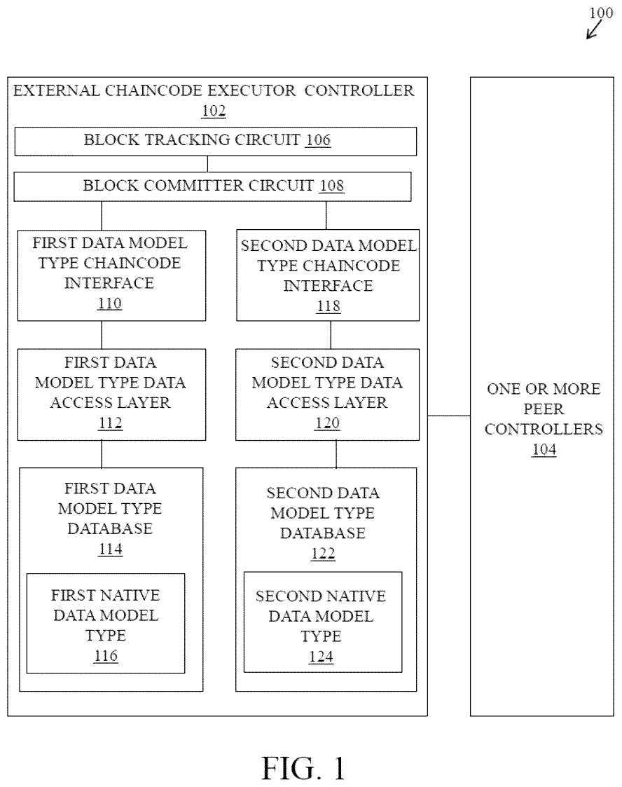

FIG. 1 is a block diagram of an external chaincode executor controller, in accordance with an embodiment of the present disclosure. With reference to FIG. 1, there is shown a block diagram 100 of an external CC executor controller 102 that includes a block tracking circuit 106 and a block committer circuit 108.

The external CC executor controller 102 is configured to receive a CC query for a non-intrusive integration of new data models into smart contract APIs. Furthermore, the external CC executor controller 102 is configured to support new data model types (i.e., a time series database or a graph database), such as by leveraging an existing piece of a Hyperledger Fabric. Examples of implementation of the external CC executor controller 102 may include but are not limited to a central data processing device, a microprocessor, a microcontroller, a complex instruction set computing (CISC) processor, an application-specific integrated circuit (ASIC) processor, a reduced instruction set computing (RISC) processor, a very long instruction word (VLIW) processor, a state machine, and other processors or control circuitry.

With reference to FIG. 1, there is shown one or more peer controllers 104 that are configured to receive a script from the external CC executor controller 102. Examples of implementation of the one or more peer controllers 104 may include but are not limited to a central data processing device, a microprocessor, a microcontroller, a CISC processor, an ASIC processor, a RISC processor, a VLIW processor, a state machine, and other processors or control circuitry.

In operation, the block tracking circuit 106 is configured to register for events with one or more peer controllers 104. In accordance with an embodiment, the block tracking circuit 106 is configured to register for new block events on all channels that a peer controller from the one or more peer controllers 104 has joined. Moreover, the external CC executor controller 102 is dedicated to the corresponding peer controller and the block tracking circuit 106 is configured to handle the CC version on the corresponding peer controller. In an implementation, the block tracking circuit 106 is configured to register for the events on a new block via a Hyperledger Fabric software development kit (SDK) API of the one or more peer controllers 104.

In accordance with an embodiment, the external CC executor controller 102 is further configured to receive a CC query, determine for which DAL the CC query is related to and cause the matching DAL to perform the CC query on the connected database. For example, the external CC executor controller 102 receives a time-range query to retrieve the data from a time-series database. Moreover, a CC query API method is used to determine the matching DAL to perform the CC query on the connected database to retrieve the data, such as through a getTSQueryResult(query_string) operation. In an example, the external CC executor controller 102 determines that the CC query relates to a first data model type DAL 112, such as through the CC query API method. In such case, the first data model type DAL 112 is configured to perform the CC query on a first data model type database 114. In another example, the external CC executor controller 102 determines that the CC query relates to a second data model type DAL 120, such as through the CC query API method. In such case, the second data model type DAL 120 is configured to perform the CC query on a second data model type database 122. Thus, the external CC executor controller 102 supports new data models to operate within a smart contract without changing the existing implementation of the blockchain platform.

Moreover, the external CC executor controller 102 includes the block committer circuit 108, which is configured to receive a new block notification and then, determine that the new block notification includes a smart contract data model. Furthermore, if the new block notification includes the smart contract data model, then the block committer circuit 108 is configured to determine if the smart contract data model relates either to the first data model type DAL 112 or to the second data model type DAL 120. Thereafter, the block committer circuit 108 is configured to dispatch the smart contract data model to the first data model type DAL 112 via a first data model type CC interface 110 when the smart contract data model relates to the first data model type DAL 112. Furthermore, the block committer circuit 108 is configured to dispatch the smart contract data model to the second data model type DAL 120 via the second data model type chaincode interface 118 when the smart contract data model relates to the second data model type DAL 120.

Furthermore, the first data model type DAL 112 is further configured to receive a data point and convert it to a native first data model type 116. Thereafter, the first data model type DAL 112 is configured to store the native first data model type 116 in the first data model type database 114. In addition, the second data model type DAL 120 is configured to receive a data point and convert it to a native second data model type 124. After that, store the native second data model type 124 in a second data model type database 122.

In an implementation, the first data model type DAL 112 is a time series data type, which is used to handle IoT workloads with an efficient and effective processing of the non-conventional data types. In another implementation, the first data model type DAL 112 is a graph data type, which is used to handle workloads that includes relationship management with an efficient and effective processing of the non-conventional data types. As a result, the external CC executor controller 102 allows the delegated smart contract execution that includes new database-specific plugins to provide different operations that are executed by different data model types, such as the time series data type and the graph data type.

In accordance with an embodiment, the first data model type DAL 112 is configured to ingest received data point elements by utilizing an ingestion method into the first data model type database 114 to perform queries over the first data model type database 114. In an implementation, the first data model type DAL 112 is the time series data type that is configured to ingest the received data point elements by utilizing an ingestion method into a time series data model type database to perform queries over the time series data model type database. In another implementation, the first data model type DAL 112 is the graph series data type that is configured to ingest the received data point elements by utilizing an ingestion method into a graph series data model type database to perform queries over the graph series data model type database (e.g., the first data model type database 114). As a result, the first data model type DAL 112 is configured to allow efficient and effective execution of the queries by the first data model type database 114 with reduced latency, such as by allowing efficient detection of the type of the data model. In accordance with an embodiment, the ingestion method causes the external CC executor controller 102 to convert an incoming point element into a key-value pair, such as Key=DATAMODEL_ID_<hash of incoming point element>, and Value=serialization of the incoming point element. Thereafter, the external CC executor controller 102 is configured to call the peer controller from one or more peer controllers 104 to inject the generated key-value pair. For example, the external CC executor controller 102 is configured to convert the incoming point element into a key-value pair as key=TS_<hash of incoming point element>, and value=serialization of the incoming point element into an influxDB line protocol string representation. Thereafter, the external CC executor controller 102 is configured to call the peer controller from the one or more peer controllers 104, such as through a putState(k,v) method with the generated key-value pair. Moreover, a smart contract calls an ingestion API, such as through the ingestion method that includes a key-value API set. In an example, the ingestion method is of a non-key-value, and the external CC executor controller 102 receives “putTSState(Point)” from the time-series (TS) provider, such as from the first data model type DAL 112. Moreover, the TS DAL is configured to transform the data point into a key-value structure and allows efficient detection of the native data type to provide a unique key, which is easy to convert the native data type back to the original data type. Thus, allows an efficient and reliable detection of the native data type, such as the native first data model type 116 and the native second data model type 124, for the generation of the unique key.

In accordance with an embodiment, the first data model type DAL 112 is configured to identify the received key-value pairs that encapsulate elements of the first smart contract data model type by utilizing a discrimination method. Firstly, the discrimination method causes the external CC executor controller 102 to accept key-value pair. Thereafter, determine if the key starts with “DATAMODEL_ID_”. Moreover, if the key starts with “DATAMODEL_ID”, then in such case, the external CC executor controller 102 is configured to return a TRUE statement, and if the key does not start with “DATAMODEL_ID” then in such case, the external CC executor controller 102 is configured to return a FALSE statement. Thus, enables the first data model type DAL 112 to identify the encapsulated data types efficiently and reliably.

In accordance with an embodiment, the block committer circuit 108 is configured to receive a transaction marked as valid from the peer controller. Moreover, the transaction includes one or more write-sets, and each write-set includes one or more key-value elements. Furthermore, the block committer circuit 108 is configured to identify a type of the value of the key-value element by matching the key with the key-value element of the DATAMODEL_IDs for the smart contract data model types. Thereafter, the block committer circuit 108 is configured to send the key-value pair to any matching smart contract data model DAL's ingestion method to perform queries over the corresponding database. For example, Finally, the block committer circuit 108 is configured to mark that the corresponding transaction has been completed. In an implementation, once a new block is validated by the peer controller, then the block committer circuit 108 is configured to receive the transaction marked as valid from the peer controller. Thereafter, the block committer circuit 108 detects the various data points for which data model type the key-value is not matching. Furthermore, such data points are routed to the matching data model DAL components to be converted back to the native data type and to be persisted in the corresponding database.

In accordance with an embodiment, the block committer circuit 108 is configured to utilize a Hyperledger Fabric block delivery book keeping to keep track of processed blocks and request only the blocks it has not fully processed yet. The Hyperledger Fabric block delivery book keeping provides a number of APIs to support the smart contract data model in various programming languages. The Hyperledger Fabric block delivery book keeping (e.g., kubernetes) allows the provisioning of the CC execution that is managed by the peer controller from one or more peer controllers 104. In addition, the external CC executor controller 102 is perceived to be stateless, and the peer controller is configured to handle all state queries, such as the CC query. Moreover, the Hyperledger Fabric block delivery book keeping allows a delegated execution of smart contracts. Hence, allowing the delegated execution of the smart contracts that support different data model types.

Thus, the external CC executor controller 102 is configured to support the delegated execution of the smart contracts data model efficiently and reliably. Furthermore, the external CC executor controller 102 provides an efficient processing of the time series data model type databases (i.e., IoT workloads), the graph data model type databases, and the like. Moreover, the external CC executor controller 102 is configured to detect the non-key-value database that is provisioned to compute new CC versions, such as by registering new block events that are used to support different data model types in a blockchain system.

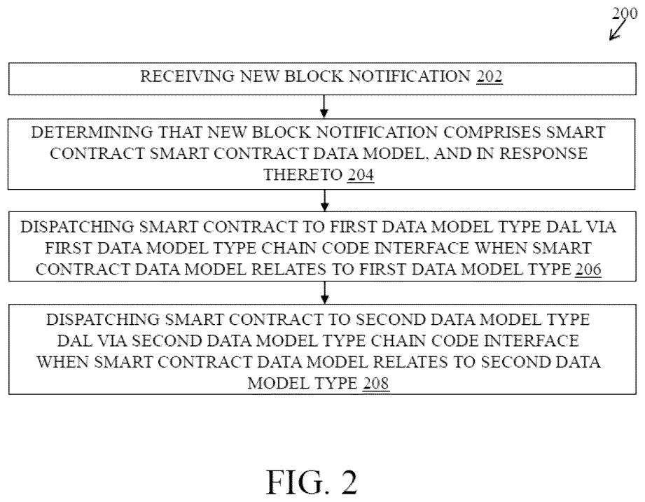

FIG. 2 is a flowchart of a method for use in an external CC executor controller, in accordance with an embodiment of the present disclosure. FIG. 2 is described in conjunction with elements from FIG. 1. With reference to FIG. 2, there is shown a flowchart of a method 200 that includes steps 202-to-208. The external CC executor controller 102 (of FIG. 1) is configured to execute the method 200.

There is provided the method 200 for use in the external CC executor controller 102. The external CC executor controller 102 includes a block tracking circuit 106 that is configured to register for events with the one or more peer controllers 104, the block committer circuit 108, the first data model type chaincode interface 110, the first data model type DAL 112 configured to receive a data point and convert it to the native first data model type 116 and store it in the first data model type database 114. The external CC executor controller 102 further includes the second data model type chaincode interface 118, and the second data model type DAL 120 configured to receive the data point and convert the data point to the native second data model type 124 and store the native second data model type 124 in a second data model type database 122.

At step 202, the method 200 comprises receiving a new block notification. Furthermore, at step 204, the method 200 further comprises determining that the new block notification comprises a smart contract data model. Moreover, if the new block notification includes the smart contract data model, then, the method 200 comprises determining if the smart contract data model relates either to the first data model type DAL 112 or to the second data model type DAL 120. Furthermore, at step 206, the method 200 further comprises dispatching the smart contract to the first data model type DAL 112 via the first data model type chaincode interface 110 when the smart contract data model relates to a first data model type DAL 112. Furthermore, at step 208, the method 200 comprises dispatching the smart contract to the second data model type DAL via the second data model type chaincode interface when the smart contract data model relates to a second data model type.

Thus, the method 200 supports the delegated execution of the smart contracts efficiently and reliably. Furthermore, the method 200 is used to provide an efficient processing of the time series data model type databases (i.e., IoT workloads), graph data model type databases and the like. Moreover, the method 200 is used to detect the non-key-value database that is provisioned to compute new chaincode versions, such as by registering new block events that is used to support different data model types in a blockchain system.

The steps 202 to 208 are only illustrative, and other alternatives can also be provided where one or more steps are added, one or more steps are removed, or one or more steps are provided in a different sequence without departing from the scope of the claims herein.

There is provided a computer program product comprising program instructions for performing the method 200 when executed by one or more processors in a blockchain system. The computer program product is implemented as an algorithm, embedded in a software stored in the non-transitory computer-readable storage medium having program instructions stored thereon, the program instructions being executable by the one or more processors in the computer system to execute the method 200. The non-transitory computer-readable storage means may include, but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, electrically erasable programmable read-only memory (ROM) (EEPROM), random-access memory (RAM), ROM, hard-disk drive (HDD), Flash memory, a Secure Digital (SD) card, solid-state drive (SSD), a computer-readable storage medium, and/or central processing unit (CPU) cache memory.

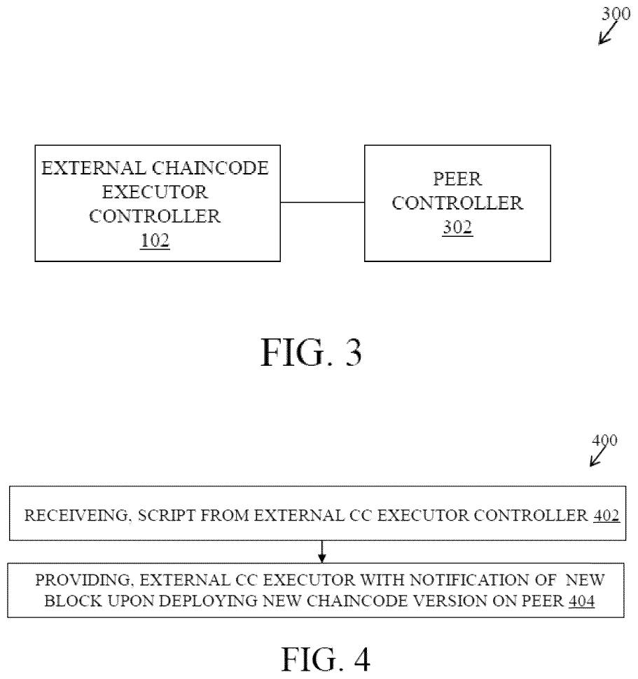

FIG. 3 is a block diagram that depicts a peer controller configured to receive a script from an external CC controller, in accordance with an embodiment of the present disclosure. With reference to FIG. 2, there is shown a block diagram 300 that depicts a peer controller 302 and the external CC executor controller 102.

The peer controller 302 is configured to receive a script from the external CC executor controller 102. Examples of implementation of the peer controller 302 may include but are not limited to a central data processing device, a microprocessor, a microcontroller, a CISC processor, an ASIC processor, a RISC processor, a VLIW processor, a state machine, and other processors or control circuitry.

In operation, the peer controller 302 is configured to receive the script from the external CC executor controller 102 and provide a notification of a new block upon deploying a new chaincode version on the peer controller 302 to the external CC executor controller 102. In an implementation, a buildpack script is deployed on a peer's file system, such as on the peer controller 302, to trigger the provisioning of the external CC executor controller 102 upon deploying the new chaincode version on the peer controller 302. In accordance with an embodiment, the peer controller 302 is configured to execute the script and thereby resolve which channel ID the chaincode has been deployed on. Furthermore, the peer controller 302 is configured to enrol the external CC executor controller 102 as an entity in Hyperledger Fabric. Thereafter, generate a unique service name for the external CC executor controller 102. Furthermore, the peer controller 302 is configured to inject the channel ID, service name ‘packageID’ of the chaincode and peer connection details to an external CC executor configuration file. Finally, the peer controller 302 is configured to call a provisioning service to provision the external CC executor controller 102 with the notification of a new block. For example, the kubernetes is a provisioning service that is called by the peer controller 302 to provision the external CC executor controller 102. Thus, the peer controller 302 is configured to support delegated execution of the smart contracts, such as by deploying the new chaincode version on the peer controller 302 with an improved efficiency and reduced latency.

FIG. 4 is a flowchart of a method for use in a peer controller configured to receive a script from an external CC executor controller, in accordance with an embodiment of the present disclosure. FIG. 4 is described in conjunction with elements from FIG. 1 and FIG. 3. With reference to FIG. 4, there is shown a flowchart of a method 400 that includes steps 402-to-404. The peer controller 302 (of FIG. 3) is configured to execute the method 400.

At step 402, there is provided the method 400 for use in the peer controller 302 that is configured to receive the script from an external CC executor controller 102. In an implementation, a buildpack script is deployed on a peer's file system, such as through the peer controller 302, to trigger the provisioning of the external CC executor controller 102 upon deploying a new chaincode version on the peer. Furthermore, at step 404, the method 400 comprises providing the external CC executor with a notification of a new block upon deploying a new chaincode version on the peer. Thus, the method 400 is used to support delegated execution of the smart contracts, such as by deploying the new chaincode version on the peer controller 302 with an improved efficiency and reduced latency.

The steps 402 to 404 are only illustrative, and other alternatives can also be provided where one or more steps are added, one or more steps are removed, or one or more steps are provided in a different sequence without departing from the scope of the claims herein.

There is provided a computer program product comprising program instructions for performing the method 400, when executed by one or more processors in a blockchain system. The computer program product is implemented as an algorithm, embedded in a software stored in the non-transitory computer-readable storage medium having program instructions stored thereon, the program instructions being executable by the one or more processors in the computer system to execute the method 400. The non-transitory computer-readable storage means may include, but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, EEPROM, RAM, ROM, HDD, Flash memory, a SD card, SSD, a computer-readable storage medium, and/or CPU cache memory.

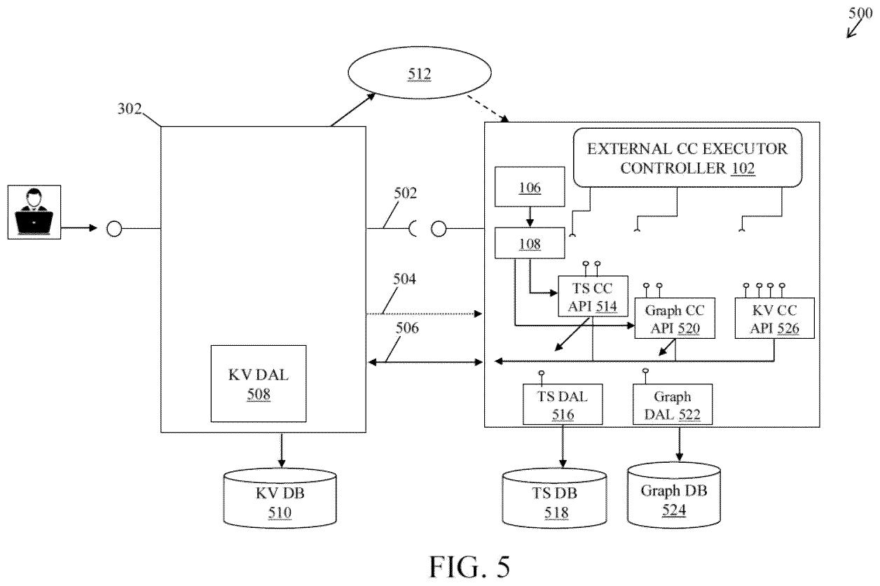

FIG. 5 is a diagram that depicts an architecture that allows a delegated execution of smart contracts, in accordance with an embodiment of the present disclosure. FIG. 5 is described in conjunction with elements from FIG. 1 and FIG. 3. With reference to FIG. 5, there is shown a diagram 500 that includes the peer controller 302 and the external CC executor controller 102 for a non-intrusive integration of new data models into smart contract APIs.

In an implementation, a Hyperledger Fabric is used to support the delegated execution of the smart contracts. Moreover, the external CC executor controller 102 is configured to register for events with the peer controller 302, such as at operation 502 through the block tracking circuit 106 that is included in the external CC executor controller 102. Thereafter, the block committer circuit 108 is configured to receive a new notification, such as through operation 504. In addition, at operation 506, the peer controller 302 is configured to perform endorsement. In an example, a key value DAL (KV DAL) 508 is used to extract a data point from a key value database (DB) 510, and the block committer circuit 108 is configured to convert an incoming data point element into a key-value pair.

The block committer circuit 108 is further configured to determine that the new block notification includes a smart contract data model, and in response thereto dispatch the smart contract data model to the time-series DAL 516 (i.e., the first data model type DAL 112) via a time-series data model type chaincode API 514 when the smart contract data model relates to the time-series DAL 516 (i.e., the first data model type DAL 112). Moreover, the time-series DAL 516 is configured to receive the data point and convert the data point to a native time-series data model type data type and store the native time-series data model type in a time-series (TS) database 518 (e.g., the first data model type database 114). In another implementation, the block committer circuit 108 is configured to determine that the new block notification comprises a smart contract data model, and in response thereto dispatch the smart contract data model to a graph-series data model type DAL 522 (i.e., the first data model type DAL 112) via a graph-series CC API 520 (i.e., the first data model type CC interface 110) when the smart contract data model relates to the graph-series DAL 522 (i.e., the first data model type DAL 112). Furthermore, the graph-series DAL 522 is configured to receive a data point and convert it to a native graph-series data model type data type and store it in a graph-series database 524 (e.g., the first data model type database 114). In addition, the smart contracts are executed via the external CC executor controller 102 to leverage new functionality enabled by the databases, such as the TS database 518, and the graph-series database 524 utilizing their data model properties and operations. In an example, a provisioning agent 512 (e.g., kubernetes) is used to monitor the peer controller 302 and the external CC executor controller 102. Hence, leveraging the ability to delegate smart contract execution, such as through new DB-specific plugins that provide new operations enabled by their data model types.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the disclosure, which are, for brevity, described in the context of a single embodiment, may also be provided separately or in any suitable combination or as suitable in any other described embodiment of the disclosure.

1. An external chaincode (CC) executor controller comprising:
a block tracking circuit configured to register for events with one or more peer controllers;
a first data model type CC interface;
a first data model type data access layer (DAL) configured to:
receive a first data point;
convert the first data point to a native first data model type to obtain a converted first data point; and
store the converted first data point in a first data model type database;
a second data model type chaincode CC interface;
a second data model type DAL configured to:
receive a second data point;
convert the second data point to a native second data model type to obtain a converted second data point; and
store the converted second data point in a second data model type database; and
a block committer circuit configured to:
receive a new block notification; and
when the new block notification comprises a smart contract data model;
dispatch the smart contract data model to the first data model type DAL via the first data model type chaincode CC interface when the smart contract data model relates to the first data model type DAL; and
dispatch the smart contract data model to the second data model type DAL via the second data model type chaincode CC interface when the smart contract data model relates to the second data model type DAL.

2. The external CC executor controller of claim 1, wherein the external CC executor controller is configured to:
receive a CC query;
determine, from between the first DAL and the second DAL, a matching DAL that relates to the CC query; and
cause the matching DAL to perform the CC query on a corresponding database, wherein the corresponding database is one of the first data model type database or the second data model type database.

3. The external CC executor controller of claim 1, wherein the first data model type DAL is further configured to:
ingest, utilizing an ingestion method, received point elements into the first data model type database; and
perform queries over the first data model type database.

4. The external CC executor controller of claim 3, wherein the external CC executor controller is configured to:
convert an incoming point element of the received point elements into a key-value pair as follows:
Key=DATAMODEL_ID_<hash of the incoming point element>; and
Value=serialization of the incoming point element; and
call a peer controller of the one or more peer controllers to inject the key-value pair.

5. The external CC executor controller of claim 1, wherein the first data model type DAL is further configured to use a discrimination method to identify received key-value pairs that are encapsulating elements of a smart contract data model type, and wherein the external CC executor controller is configured to use the discrimination method to:
accept a key-value pair of the received key-value pairs;
return TRUE when a key in the key-value pair starts with “DATAMODEL_ID_”; and
return FALSE when the key does not start with “DATAMODEL_ID_”.

6. The external CC executor controller of claim 1, wherein the block committer circuit is further configured to:
receive, from a peer controller of the one or more peer controllers, a transaction that is marked as valid, wherein the transaction comprises one or more write-sets, and wherein each of the one or more write-sets comprises one or more key-value elements;
identify a type of a value of the one or more key-value elements by matching a key of the one or more key-value elements with DATAMODEL_IDs for smart contract data model types;
send, to an ingestion method of a matching smart contract data model DAL, the one or more key-value elements; and
mark that the transaction is completed.

7. The external CC executor controller of claim 6, wherein the block committer circuit is further configured to:
utilize a Hyperledger Fabric block delivery book keeping to keep track of processed blocks; and
request blocks that have not fully processed.

8. The external CC executor controller of claim 1 further comprising a block tracker circuit configured to:
register for new block events on channels that a peer controller of the one or more peer controllers has joined; and
handle a CC version that the external CC executor controller is dedicated to.

9. The external CC executor controller of claim 1, wherein the first data model type DAL is a time series data type.

10. The external CC executor controller of claim 1, wherein the first data model type DAL is a graph data type.

11. A peer controller comprising:
a memory configured to store instructions; and
one or more processors coupled to the memory, wherein when executed by the one or more processors, the instructions cause the peer controller:
receive, from an external chaincode (CC) executor controller, a script, wherein the script instruct to provision the external CC executor controller;
deploy a new CC version on the peer controller; and
provide, based on the script and to the external CC executor controller, a notification of a new block upon deploying the new CC version.

12. The peer controller of claim 11, wherein when executed by the one or more processors, the instructions further cause the peer controller to execute the script and thereby:
resolve which channel identifier (ID) the new CC version is deployed on;
enroll the external CC executor controller as an entity in Hyperledger Fabric;
generate a unique service name for the external CC executor controller;
inject the channel ID, service name ‘packageID’ of the new CC version, and Peer connection details to an external executor configuration file; and
call a provisioning service to provision the external CC executor controller with the notification.

13. A method implemented by an external chaincode (CC) executor controller wherein the method comprises:
registering, using a block tracking circuit of the external CC executor controller, for events with one or more peer controllers;
receiving, using a first data model type access layer (DAL) of the external CC executor controller, a first data point;
converting, using the first data model type DAL, the first data point to a native first data model type data type to obtain a converted first data point;
storing, using the first data model type DAL, the converted first data point in a first data model type database of the external CC executor controller;
receiving, using a second data model type DAL of the external CC executor controller, a second data point;
converting, using the second data model type DAL, the second data point to a native second data model type data type to obtain a converted second data point;
storing, using the second data model type DAL, the converted second data point in a second data model type database of the external CC executor controller;
receiving, using a block committer circuit of the external CC executor controller, a new block notification; and
when the new block notification comprises a smart contract data model;
dispatching the smart contract data model to the first data model type DAL via a first data model type CC interface of the external CC executor controller when the smart contract data model relates to the first data model type DAL; and
dispatching the smart contract data model to the second data model type DAL via a second data model type CC interface of the external CC executor controller when the smart contract data model relates to the second data model type DAL.

14. The method of claim 13, further comprising:
receiving a CC query;
determining, from between the first DAL and the second DAL, a matching DAL that relates to the CC query; and
causing the matching DAL to perform the CC query on a corresponding database, wherein the corresponding database is one of the first data model type database or the second data model type database.

15. The method of claim 13, further comprising:
ingesting, using the first data model type DAL and an ingestion method, received point elements into the first data model type database; and
performing, using the first data model type DAL, queries over the first data model type database.

16. The method of claim 15, further comprising:
converting an incoming point element of the received point elements into a key-value pair as follows:
Key=DATAMODEL_ID_<hash of the incoming point element>; and
Value=serialization of the incoming point element; and
calling a peer controller of the one or more peer controllers to inject the key-value pair.

17. The method of claim 13, further comprising:
identifying, using the first data model type DAL and a discrimination method, received key-value pairs that are encapsulating elements of a smart contract data model type;
accepting, using the discrimination method, a key-value pair of the received key-value pairs;
determining, using the discrimination method, whether a key in the key-value pair starts with “DATAMODEL_ID_”;
returning, using the discrimination method, TRUE when a key in the key-value pair starts with “DATAMODEL_ID_”; and
returning, using the discrimination method, FALSE when the key does not start with “DATAMODEL_ID_”.

18. The method of claim 13, further comprising:
receiving, using the block committer circuit and from a peer controller of the one or more peer controllers, a transaction that is marked as valid, wherein the transaction comprises one or more write-sets, and wherein each of the one or more write-sets comprises one or more key-value elements;
identifying, using the block committer circuit, a type of a value of the one or more key-value elements by matching a key of the one or more key-value elements with DATAMODEL_IDs for smart contract data model types;
sending, using the block committer circuit and to an ingestion method of a matching smart contract data model DAL, the one or more key-value elements; and
marking, using the block committer circuit, that the transaction is completed.

19. The method of claim 18, further comprising:
utilizing, using the block committer circuit, a Hyperledger Fabric block delivery book keeping to keep track of processed blocks; and
requesting, using the block committer circuit, blocks that have not fully processed.

20. The method of claim 13, further comprising:
registering, using a block tracker circuit, for new block events on channels that a peer controller of the one or more peer controllers has joined; and
handling, using a block tracker circuit, a CC version that the external CC executor controller is dedicated to.
